(19) United States
(12) Patent Application Publication
(10) Pub. No.: US 2008/0245634 A1
(43) Pub. Date: Oct. 9, 2008

(54) MACHINE UNIT WITH A DRIVE SYSTEM AND A MACHINE

(75) Inventors: Andreas Basteck, Lorrach (DE); Hans Schirle, Stimpfach (DE); Harald Hoffeld, Crailsheim (DE)

Correspondence Address: BAKER & DANIELS LLP;111 E. WAYNE STREET, SUITE 800, FORT WAYNE, IN, 46802, US

(73) Assignee: Voith Patent GmbH, Heidenheim (DE)

(21) Appl. No.: 11/970,095

(22) Filed: Jan. 7, 2008

(30) Foreign Application Priority Data
Jan. 31, 2007 (DE) 10 2007 005 661.5

(51) Int. Cl. F16D 35/00

(52) U.S. Cl. 192/3.3

(57) ABSTRACT

The invention relates to a high output machine unit;
with a drive system provided with an output shaft;
with a machine provided with a drive shaft;
with a fillable and dischargeable hydrodynamic coupling arranged between the drive system and the machine;

with a mechanical coupling arranged parallel to the hydrodynamic coupling;
one half of the mechanical coupling can be connected non-rotationally to the output shaft of the drive system;

the other half of the mechanical coupling can be connected non-rotationally to the drive shaft of the machine.

The invention relates to a machine unit with a drive system and a machine. The invention relates in particular to a machine unit where the drive system is an electric motor or a gas turbine and the machine is a compressor. Such cases involve extremely high power outputs, with a magnitude of 20 Megawatt and over. Owing to the extremely high power outputs, the machines also have extraordinarily large rotational masses, a fact that naturally leads to special problems as a consequence.

The demands upon a machine unit of the aforementioned kind, especially with a gas turbine and a compressor are as follows:
the compressor must be started up in such a way that the drive system is not overloaded
the compressor must be run up to a speed that is equivalent to the speed of the drive system, which means that the two machines must run synchronously in relation to each other
after achieving synchronisation, a direct mechanical drive connection must be created between the drive system and the machine
with some machine units of the aforementioned kind, in particular comprising a gas turbine as the drive system and a compressor as the machine, it may be necessary to allow the gas turbine to run continuously, even if the compressor is switched off.

WO 02/14716 describes a machine unit of the kind mentioned at the outset. This involves a hydrodynamic and dischargeable converter being located between the gas turbine and the compressor. The operation of the aforementioned converter requires active intervention. A control unit is required for this purpose.

The object of the present invention is to make provision for a machine unit with a drive system, a machine and a transfer element located between these two, in particular with a gas turbine and a compressor which is designed for extremely high outputs and speeds, with which the machine can be reliably started and the drive system started in a gentle manner, where the drive system and the machine can be run up to synchronous speeds, with the drive system able to continue operating although the machine has been deactivated. The machine unit is to be designed in a more simple and cost effective manner.

The inventors have found a perfect solution to the problem, with each of the partial objectives being resolved.

The hydrodynamic coupling in accordance with the invention can be filled and emptied. Half of the coupling of the mechanical coupling is paired with the pump wheel of the hydrodynamic coupling and the other half of the coupling with the turbine wheel. The mechanical coupling can for instance be a sliding switch coupling, where the two halves of the coupling can be engaged by sliding them axially. The mechanical coupling can be a friction coupling.

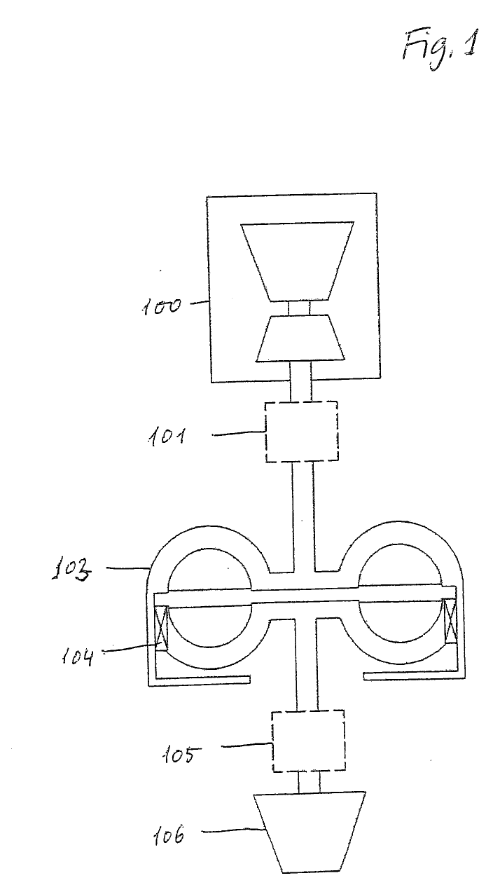

The principle of the friction coupling is described for instance in DE 19942578 AI An that instance, a synchromesh coupling is integrated into a hydrodynamic coupling. It comprises two coupling elements that can be functionally connected in a non-positive manner. These coupling elements are formed by the coupling shell and the inner wheel of the hydrodynamic coupling. See FIG. 1 a of the specified document.

Running up occurs as follows, described with reference to an example of a machine unit with a gas turbine and a compressor:
(1) Firstly, the gas turbine is activated; the compressor is idle,
(2) The hydrodynamic coupling is filled.
(3) The compressor is run up by the drive system as a result of filling the hydrodynamic coupling, until it is running in synchronisation with the drive system.
(4) Sensors detect when synchronisation occurs.
(5) Then the mechanical coupling is switched on. After the mechanical coupling is activated, the torque is transferred from the gas turbine to the compressor along two paths, namely via the hydrodynamic coupling on the one hand, and via the mechanical coupling on the other. The two power flows run parallel to each other.
(6) Then, the hydrodynamic coupling is emptied, so that only the mechanical coupling is transferring torque from the gas turbine to the compressor.

A friction coupling can be used as the mechanical coupling.

The machine unit can be operated in two ways during deactivation.

Option A:
(1) The gas turbine is deactivated and runs down more or less with the compressor.
(2) The coupling is disengaged, resulting from either an intended intervention or automatically.
(3) The drive system and compressor come to a standstill decoupled from each other.

A friction coupling can be used as the mechanical coupling.

Option B:
(1) The empty hydrodynamic coupling is filled again with the working fluid.
(2) The mechanical coupling is disengaged.
(3) The hydrodynamic coupling is emptied. Although the gas turbine continues to run, torque is no longer transferred to the compressor, so that this runs down to a standstill.

Option B can be particularly advantageous. Fields of application are conceivable where the compressor is only deployed intermittently, but the gas turbine is to keep running for reasons relating to the gas turbine process.

The invention is described in more detail with reference to the drawing. It shows the following:

FIG. 1 shows a machine unit in a schematic representation.

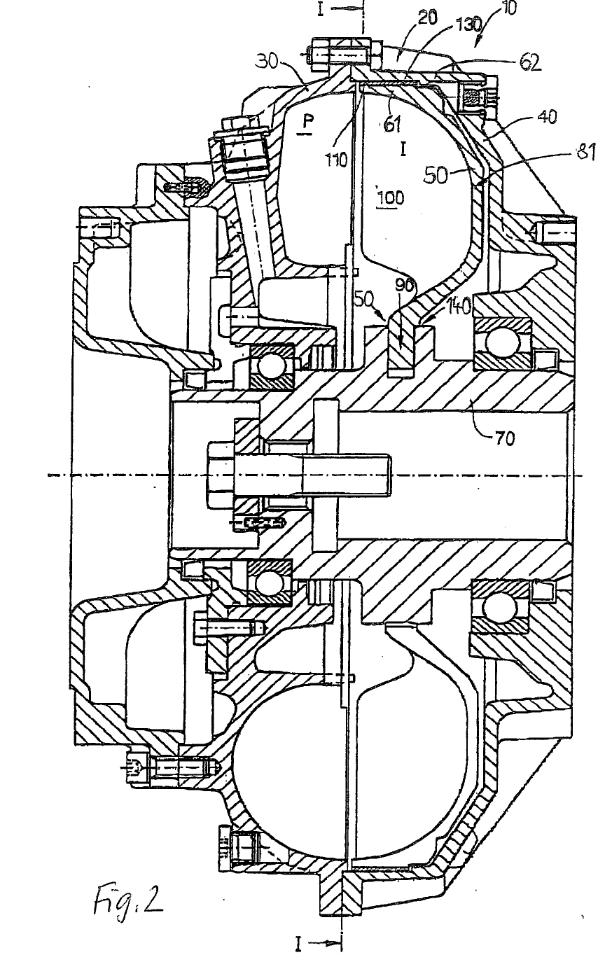

FIG. 2 shows a hydrodynamic coupling with an integrated mechanical coupling in axial cross-section.

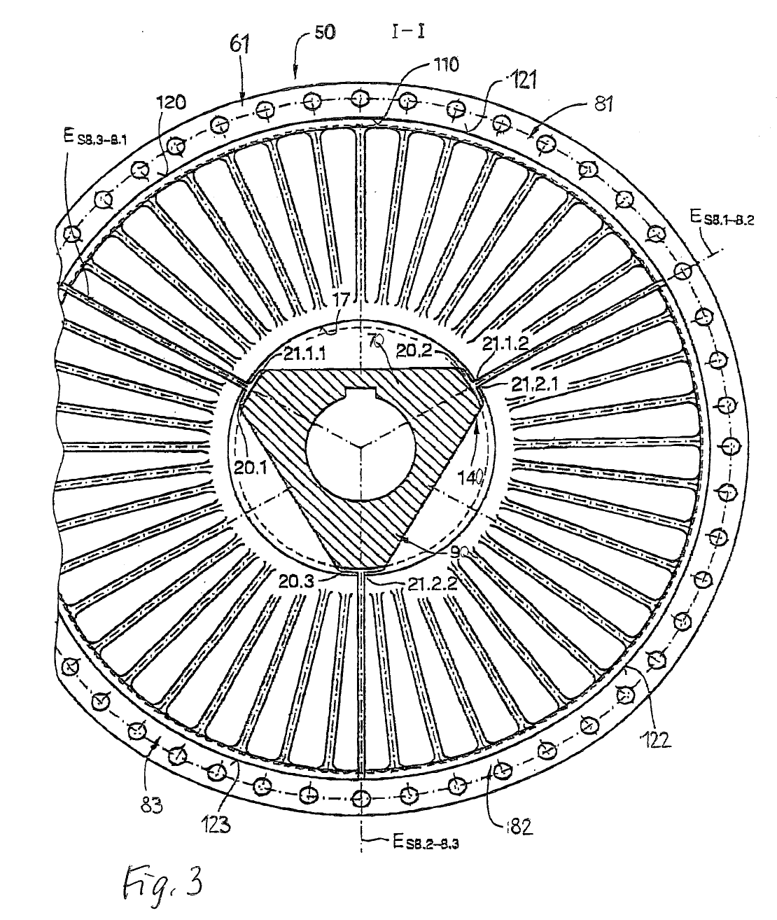

FIG. 3 shows the object from FIG. 2 in the view I-I from FIG. 2.

The schematic representation according to FIG. 1 shows a motor 100. This can be a gas turbine or an electric motor or another machine for generating torque.

A transmission 101 is located on the load side of the motor 100. From case to case, this can be dispensed with.

A hydrodynamic coupling 103 follows. This can be filled and emptied. A mechanical coupling 104 can be engaged, so that torque is transferred.

A further transmission 105 can be connected on the load side.

Finally, a motor 106 follows. This is, for instance, a compressor for compressing natural gas.

FIGS. 2 and 3 show a particularly favourable embodiment of the hydrodynamic and mechanical coupling.

The hydrodynamic coupling comprises two impellers, an external wheel 30 and an inner wheel 50 that is at least partially enclosed by a coupling shell 40 coupled with the outer wheel 30. Preferably, the outer wheel 30 functions as a pump wheel, while the inner wheel 50 assumes the function of the turbine wheel. For this purpose, when deployed in drive trains, the outer wheel 30 is non-rotatably connected at least indirectly with the drive side, in particular with a motor, while the inner wheel 50 forming the turbine wheel is coupled with the output side. This applies for the transmission of power in a drive train in traction mode observed from the motor to the output side. The synchromesh unit 20 is integrated into the hydrodynamic coupling 10 and comprises at least two non-positive coupling elements that can be functionally connected, a first coupling element 61 and a second coupling element 62. In accordance with the invention, the coupling elements are formed by the coupling shell 40 and the inner wheel 50 of the hydrodynamic coupling. The inner wheel 50 forms the coupling element 61 and is developed in accordance with the invention as a multipart centrifugal body. This means that the inner wheel 50 or the coupling element 61 is subdivided into at least two segments circumferentially, which in their entirety can be moved at least radially when mounted and/or run on a profiled shaft or hub 70 when subject to centrifugal force. Preferably, subdivision is in three individual segments 81, 82, and 83. The individual segments form the structural unit constituting the inner wheel 50 when rubbing against each other in the direction of the periphery and are preferably developed identically to each other with respect to their geometric dimensions. As the inner wheel 50 is to transmit torque in a hydrodynamic coupling 10, the inner wheel 50, in particular the individual segments when viewed in the peripheral orientation, must at the least be developed such that a drive function is guaranteed, while radially there is movement of the individual segments 81 to 83 subject to the effect of centrifugal force. For this purpose, provision is made for means to drive the individual segments 81 to 83, which as a rule are formed by the profiled shaft or hub 70. This can at least indirectly be connected non-rotatably with the output side, depending on the function of the inner wheel 50. The profiled shaft or hub 70 is provided with a corresponding drive profile 90 for this purpose.

During the start-up procedure employing the hydrodynamic coupling 10, the torque is predominantly transmitted hydrodynamically by means of the operating fluid. Consequently, the soft start-up is maintained by using the advantages of hydrodynamic power transmission. However, with the increase in output speed resulting from the increasing centrifugal effect upon the individual segments 81 to 83 of the inner wheel, these are increasingly pushed in the direction of the coupling shell 40 until a frictional connection is created by the segments 81 to 83 pressing against the coupling shell 40. In this state, the coupling is synchronised as a result of the coupling between the outer wheel 30, i.e. impeller P and the coupling shell 40. All the elements run with the same rotational speed.

As the individual segments 81 to 83 on the inner periphery 110 of the coupling shell 40 are gliding during the start-up process, this means that the individual elements of the friction pair must display good anti-frictional and wear characteristics at least in the area of the frictional connection to be formed. Decisive factors impacting upon the wear resistance of the friction pair between the inner wheel 50 and the coupling shell 40 created at the synchromesh unit 20 are the resultant surface pressure, the specific frictional drive and the specific work generated by friction. Consequently, in order to minimise wear, either the appropriate materials are used for the coupling shell 40 and the inner wheel 50, in particular the individual segments 81 to 83, or these are equipped with an appropriate coating. Preferably, conventional materials are used at least for the production of the coupling shell 40 and the impeller, i.e. the outer wheel 30, materials which are conventionally employed for manufacturing individual elements of the hydrodynamic coupling 10, for example spheroidal cast iron.

The following factors are taken into account when selecting the material for the inner wheel 50 and/or the individual inner wheel segments 81 to 83. In order to increase availability it is advantageous to make provision for a suitable frictional pair between the coupling shell 40 and the segments 81 to 83 of the inner wheel 50. Provision is made for coatings with a friction lining 130 either on one of the elements or on both—in particular on the inner periphery 110 of the coupling shell and on the outer periphery 120 of the inner wheel 50, in particular on each of outer periphery 121 of segment 82 and [outer periphery] 123 of segment 83. In this case, on the one hand the friction lining can be attached only on the inner periphery 110 of the coupling shell 40 or on the outer periphery 120 of the inner wheel 50 and/or of the individual segments 81 to 83, but it is also conceivable to coat both —the coupling shell 40 on its inner periphery 110 and the inner wheel 50 on the outer periphery 120 and/or in the individual segments 81 to 83 on the individual outer peripheries 121 to 123—with an appropriate friction lining, with friction pairs able to be produced in this case with the same materials or different materials.

An axial force impinges on the inner wheel 50 during hydrodynamic power transmission. To absorb the axial force, provision is made for appropriate means 140 for taking up this axial force on the inner wheel 50, in particular on the individual segments 81 to 83 of the inner wheel 50. These are either formed by the drive means 90, in particular the driving profile 90 on the profiled shaft or hub 70 or taken up by means of an additional drive 150 not shown here on the periphery of the coupling shell 40. The means for taking up the axial forces 140 are to be designed for taking up an axial force acting in both directions, as the axial force acts alternately.

1. High output machine unit;
with a drive systems provided with an output shaft;
with a machine provided with a drive shaft;
with a fillable and dischargeable hydrodynamic coupling arranged between the drive system and the machine;
with a mechanical coupling arranged parallel to the hydrodynamic coupling;
one half of the mechanical couplings can be connected nonrotationally to the output shaft of the drive system;
the other half of the mechanical coupling can be connected nonrotationally to the drive shaft of the machine.

2. Machine unit in accordance with claim 1, characterised by the following features:
the mechanical coupling is a friction coupling;
the friction coupling operates in conjunction with a transmission actuator;
the transmission actuator is provided with a hydraulic unit with a piston and a cylinder, which can be pressurised in the sense of closing the friction coupling by means of a pressure medium that can be applied via a medium connection;
provision is made for a return spring, which acts in the sense of opening the friction coupling.

3. Machine unit in accordance with claim 1, characterised by the following features:
provision is made for sensors for measuring the speed of the drive machine and the work machine;
provision is made for a device for blocking off the connection for the medium and for releasing the medium from the hydraulic unit.

4. Machine unit in accordance with claim 1, wherein the drive system is a gas turbine and the work machine is a compressor.

5. Machine unit in accordance with claim 1, characterised by the following features:
the mechanical coupling is a synchromesh unit, comprising at least two coupling elements, which can be functionally connected nonpositively with each other at least indirectly;
the inner wheel of the hydrodynamic coupling is subdivided into at least two segments, which are displaceably mounted radially and can be circumferentially connected non-rotationally to the drive or output side;
the first coupling element of the synchromesh coupling is formed by the segments of the inner wheel, and the second coupling element by the coupling shell,

6. Machine unit in accordance with claim 5, wherein the individual segments of the inner wheel are identical with respect to their form and their geometric dimensions.

7. Machine unit in accordance with claim 2, wherein the drive system is a gas turbine and the work machine is a compressor.

8. Machine unit in accordance with claim 3, wherein the drive system is a gas turbine and the work machine is a compressor.
